(19) United States
(12) Patent Application Publication
(10) Pub. No.: US 2009/0186330 A1
(43) Pub. Date: Jul. 23, 2009

(54) REUSABLE AD HOC SELF-POSED QUESTIONS AND ANSWERS FOR SOCIAL NETWORK PROFILES

(75) Inventors: Elizabeth A. Brownholtz, Andover, MA (US); Joan M. DiMicco, Brookline, MA (US); Casey Dugan, Medford, MA (US); Werner Geyer, Boston, MA (US); David R. Millen, Boxford, MA (US); Michael Muller, Medford, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/017,028

(22) Filed: Jan. 19, 2008

(51) Int. Cl. G09B 7/00; G06F 15/16

(52) U.S. Cl. 434/362; 434/322; 709/201

(57) ABSTRACT

Embodiments of the present invention address deficiencies of the art in respect to profile generation for social networking systems and provide a method, system and computer program product for reusable ad hoc self-posed questions and answers for social network profiles. In an embodiment of the invention, a method for managing reusable ad hoc self-posed questions and answers for social network profiles can be provided. The method can include receiving a free form specification of a question and a corresponding answer by a particular user in a social network, posting the received question and corresponding answer onto a user profile for the particular user, selecting the received question for the particular user on behalf of a different user in the social network and prompting the different user to provide a different answer to the selected question, and posting the selected question and the different answer onto a user profile for the different user.

### BACKGROUND OF THE INVENTION

1. Field of the Invention

The present invention relates to the field of social networking and more particularly to navigational pivot points for social networks.

2. Description of the Related Art

A social network refers to a social structure of nodes each associated with a different person or organization. The interconnections of each node reflect direct relationships between the respective people and organizations such that the directness of a relationship between two persons or organizations associated with respective nodes can be summarized by the path of interconnections between the respective nodes. In this way, any one individual in a social network can evaluate the number and quality of social relationships with others in the network, those relationships ranging from close familial bonds to casual acquaintances.

The advent of the global Internet has changed the way in which social networks can be viewed. Originally, a mere visual tool describing a social phenomenon, computerized social networks facilitate the recognition and expansion of social networks amongst interacting users across the globe. Whereas geographic boundaries previously limited the extent and quality of a given social network, the global Internet enables limitless expansion of the social network based upon a vast set of aware collaborators coupled by the fabric of computer communications.

Commercial computerized social networks have become wildly popular in recent years—especially amongst the younger demographic. Examples include the MySpace™ computer socialized network maintained by MySpace, Inc. of Los Angeles, Calif., LinkedIn™ computerized business network maintained by LinkedIn Corporation of Palo Alto, Calif., and the Facebook™ computerized social network maintained by Facebook of Palo Alto, Calif. Commercial computerized social networks represent social networking services connecting users according to different types of interests in an aggregated view—generally a Web site hosting user contributed content through imagery and commentary.

Commercial computerized social networks allow users to create individual profiles. Each profile can include social media including imagery such as photographs of the user and things relevant to the user. Each profile further can include textual materials such as lifestyle information, or general writings. Notably, users can establish networks of favorite “friends”. Favorite friends can be specified manually by a given user and often represent the individuals or organizations most favored by the given user. Each of the favorite friends can be presented in the Web site so as to allow linking to a corresponding profile for the favorite friend. In this way, an end user literally can navigate shared social media in the social network for a given user.

Generally, the profile for each user in a social network is fixed in form. That is to say, the social network provides a standard interface with standard data fields to be completed by each user in order to establish a profile. The data fields usually pertain to demographic data, favorite music, occupation, travel preferences, reading and entertainment preference and the like. However, the rigid nature of fixed data fields prevents a range of self-expression and flexibility otherwise associated with those who participate in social networks.

### BRIEF SUMMARY OF THE INVENTION

Embodiments of the present invention address deficiencies of the art in respect to profile generation for social networking systems and provide a novel and non-obvious method, system and computer program product for reusable ad hoc self-posed questions and answers for social network profiles. In an embodiment of the invention, a method for managing reusable ad hoc self-posed questions and answers for social network profiles can be provided. The method can include receiving a free form specification of a question and a corresponding answer by a particular user in a social network, posting the received question and corresponding answer onto a user profile for the particular user, selecting the received question for the particular user on behalf of a different user in the social network and prompting the different user to provide a different answer to the selected question, and posting the selected question and the different answer onto a user profile for the different user.

In another embodiment of the invention, a social networking data processing system can be provided. The system can include a social networking application executing in a host server and configured for communicative coupling to different clients over a computer communications network. The system also can include a set of user profiles each corresponding to a different user of the social networking application. The system yet further can include a data store of free form question and answer pairs provided by different users of the social networking application. Finally, question-and-answer pair management logic can be coupled to the social networking application. The logic can include program code enabled to select a question in the data store of free form question-and-answer pairs in connection with a corresponding question-and-answer pair for a first user, to prompt a second user to provide an answer to the selected question, and to post the selected question and provided answer onto a user profile for the second user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for managing reusable ad hoc self-posed questions and answers for social network profiles;

FIGS. 2A and 2B, taken together, are a pictorial illustration of a user interface for managing reusable ad hoc self-posed questions and answers for social network profiles;

FIG. 3 is a schematic illustration of a social networking data processing system configured for reusable ad hoc self-posed questions and answers for social network profiles; and,

FIG. 4 is a flow chart illustrating a process for managing reusable ad hoc self-posed questions and answers for social network profiles.

### DETAILED DESCRIPTION OF THE INVENTION

Embodiments of the present invention provide a method, system and computer program product for reusable ad hoc self-posed questions and answers for social network profiles. In accordance with an embodiment of the present invention, free form questions and answer pairs can be posed and answered by a user of a social network for inclusion in a user profile in the social network. Question-and-answer pairs once established can be re-used by other users in the social network. Specifically, questions in question-and-answer pairs can be re-posed to a different user and a different answer can be provided by the different user in order to produce a new question-and-answer pair to be included in the user profile of the different user. Reporting and analysis further can be provided for different question-and-answer pairs.

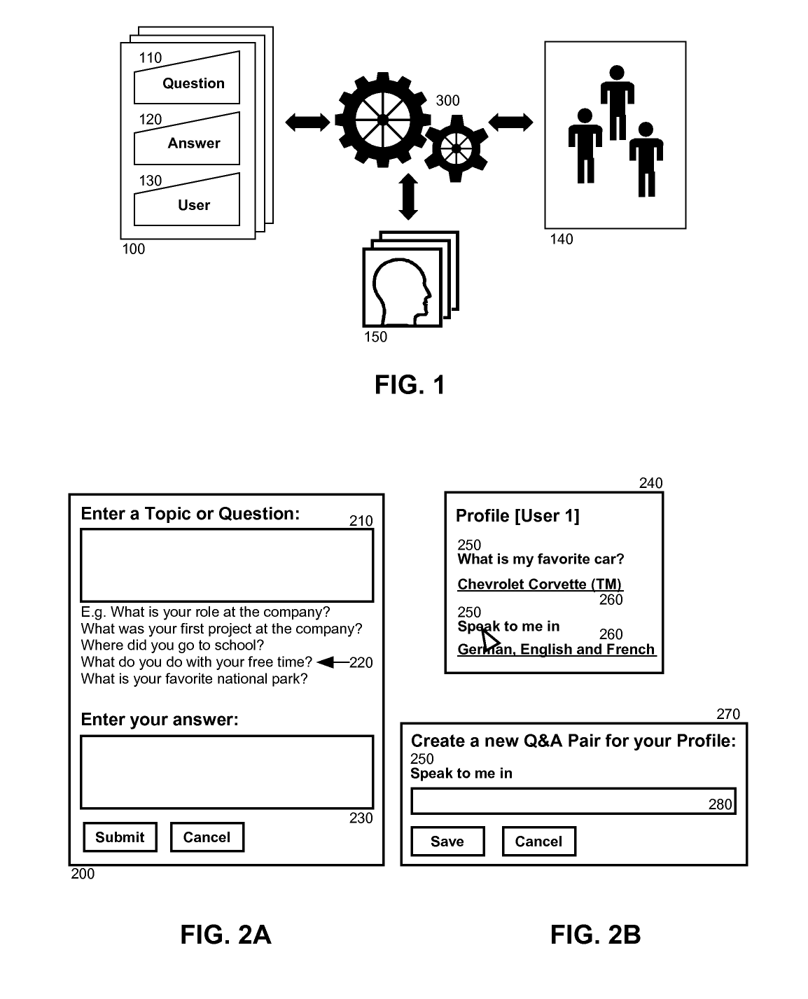

In further illustration, FIG. 1 is a pictorial illustration of a process for managing reusable ad hoc self-posed questions and answers for social network profiles. As shown in FIG. 1, a set of question-and-answer pairs 100 can be provided ad hoc by different users 140 of a social network. Each question-and-answer pair 100 can include a free-form question 110 and a free-form answer 120 as well as information describing the individual one of the users 140 creating the question-and-answer pair 100. Once created, the question-and-answer pair 100 can be stored in connection with a user profile 150 for the user 140. In this way, other users 140 can view the question-and-answer pairs 100 for one another through respective views of the user profiles 150.

A social networking data processing system 300 can be configured to manage the questions and answer pairs 100 for re-usability in the social network. In this regard, when viewing a question-and-answer pair 100 in the profile of a particular user, a different user of the social network can elect to provide an answer 120 to the question 110 in the question-and-answer pair 100 and to post a new question-and-answer pair 100 in the user profile of the different user. In this way, the question-and-answer pair 100 can achieve an influencing socially viral effect upon other users 140 of the social network.

To effectuate the process of FIG. 1, several user interface elements can be introduced into a social networking environment relating to the creation and reuse of question-and-answer pairs 100. In further illustration, FIGS. 2A and 2B, taken together, are a pictorial illustration of a user interface for managing reusable ad hoc self-posed questions and answers for social network profiles. For example, in reference to FIG. 2A, a user interface 200 can be provided in which a question-and-answer pair can be defined. The user interface 200 can provide a question free-form data entry field 210 and an answer free-form data entry field 230. Optionally, a suggestion textual element 220 can be displayed in the user interface 200 in order to suggest different questions which may have been previously posed questions.

Referring now to FIG. 2B, the questions 250 and answers 260 posed by different users of the social network can be displayed in corresponding profile pages 240 in the social network. The question-and-answer pairs of the different users can be reused in the sense that a viewer of the profile page 240 of a user can select a question 250 for reuse. In response, a reuse dialog 270 can be presented incorporating the selected question 250 and providing a free form text entry field 280 for the answer. The new combination of question and answer can be saved as a different question-and-answer pair in the profile page of the viewer. Optionally, the reuse dialog 270 can be invoked for different users of the social network with a question posed by another user in the social network.

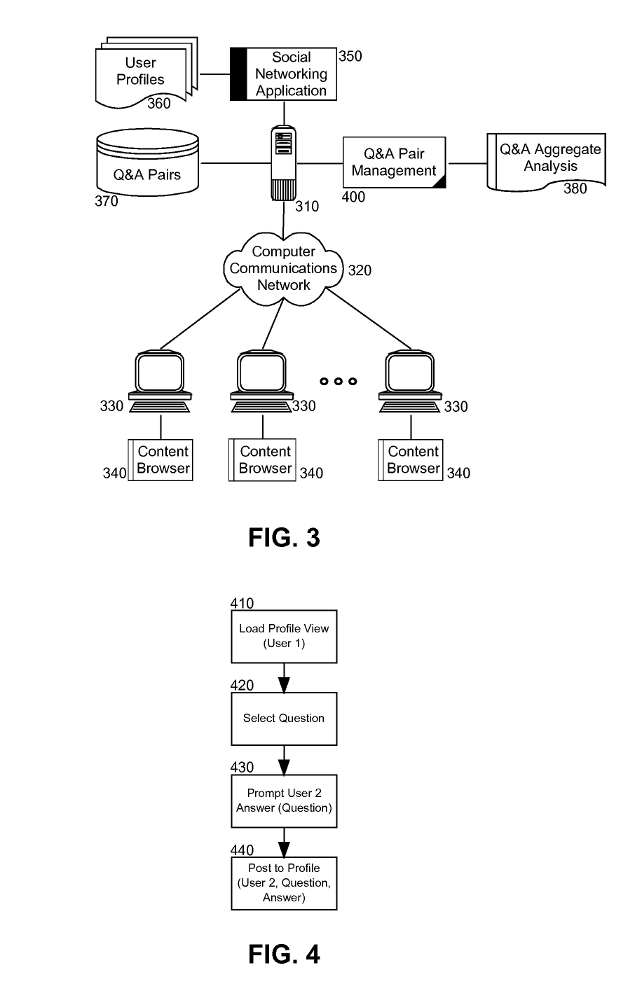

The user interface shown herein can be generated within a social networking data processing system. In yet further illustration, FIG. 3 is a schematic illustration of a social networking data processing system configured for reusable ad hoc self-posed questions and answers for social network profiles. The system can include a host server 310 configured for communicative coupling to multiple different clients 330 over computer communications network 320. The host server 210 can support the operation of a social networking application 350 configured for access by different users through respective content browsers 340, each supported by a separate one of the clients 330. The social networking application 350 can be coupled to a set of user profiles 360, one for each of the users of a social network provided by the social networking application 350.

Notably, question-and-answer pair management logic 400 can be coupled to the social networking application 350 through the host server 310. Further, the question-and-answer pair management logic 400 can be coupled to a data store of question-and-answer pairs 370 storing different question-and-answer pairs for different users of the social network. The question-and-answer pair management logic 400 can include program code enabled to collect ad hoc free form question-and-answer pairs for the users of the social network. Further, the program code can be enabled to store copies of the question-and-answer pairs in different user profiles 360 for respectively different users of the social network creating the question-and-answer pairs.

In yet further illustration of the operation of the question-and-answer pair management logic 400, FIG. 4 is a flow chart illustrating a process for managing reusable ad hoc self-posed questions and answers for social network profiles. Beginning in block 410, a profile view of one user can be loaded by a different user and in block 420, a question in a question-and-answer pair can be selected. In block 430, the different user can be prompted to provide an answer to the selected question and a new question-and-answer pair can be formed from the selected question and the answer provided by the different user. Finally, in block 440, the new question-and-answer pair can be posted to a profile for the different user.

Returning now to FIG. 3, question and answer aggregate analysis module 380 can be coupled to the question-and-answer pair management logic 400. The question and answer aggregate analysis module 380 can be configured to generate reports of different questions and answers amongst the question-and-answer pairs 370. The reports can include a listing of all users answering a particular question, or a listing of all questions posed by the users. The listing of questions can be filtered according to most recent or most reused or most popular. The reports also can indicate for each reused question-and-answer pair the source of the reused question-and-answer pair.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for managing reusable ad hoc self-posed questions and answers for social network profiles, the method comprising:
receiving a free form specification of a question and a corresponding answer by a particular user in a social network;
posting the received question and corresponding answer onto a user profile for the particular user;
selecting the received question for the particular user on behalf of a different user in the social network and prompting the different user to provide a different answer to the selected question; and,
posting the selected question and the different answer onto a user profile for the different user.

2. The method of claim 1, further comprising providing a textual suggestion of multiple different questions.

3. The method of claim 1, further comprising:
proposing a question to multiple users in the social network;
receiving different answers from the multiple users to the proposed question; and,
posting different question-and-answer pairs for each of the multiple users to respective user profiles in the social network.

4. The method of claim 1, further comprising reporting a listing of questions associated with corresponding answers provided by different users in the social network.

5. The method of claim 4, further comprising filtering the listing of questions according to a criterion of most popular questions.

6. The method of claim 4, further comprising filtering the listing of questions according to a criterion of most recently posed questions.

7. The method of claim 1, further comprising linking the selected question and the different answer with the received question and corresponding answer.

8. A social networking data processing system comprising:
a social networking application executing in a host server and configured for communicative coupling to different clients over a computer communications network;
a set of user profiles each corresponding to a different user of the social networking application;
a data store of free form question-and-answer pairs provided by different users of the social networking application; and,
question-and-answer pair management logic coupled to the social networking application, the logic comprising program code enabled to select a question in the data store of free form question-and-answer pairs in connection with a corresponding question-and-answer pair for a first user, to prompt a second user to provide an answer to the selected question, and to post the selected question and provided answer onto a user profile for the second user.

9. A computer program product comprising a computer usable medium embodying computer usable program code for managing reusable ad hoc self-posed questions and answers for social network profiles, the computer program product comprising:
computer usable program code for receiving a free form specification of a question and a corresponding answer by a particular user in a social network;
computer usable program code for posting the received question and corresponding answer onto a user profile for the particular user;
computer usable program code for selecting the received question for the particular user on behalf of a different user in the social network and prompting the different user to provide a different answer to the selected question; and,
computer usable program code for posting the selected question and the different answer onto a user profile for the different user.

10. The computer program product of claim 9, further comprising computer usable program code for providing a textual suggestion of multiple different questions.

11. The computer program product of claim 9, further comprising:
computer usable program code for proposing a question to multiple users in the social network;
computer usable program code for receiving different answers from the multiple users to the proposed question; and,
computer usable program code for posting different question-and-answer pairs for each of the multiple users to respective user profiles in the social network.

12. The computer program product of claim 9, further comprising computer usable program code for reporting a listing of questions associated with corresponding answers provided by different users in the social network.

13. The computer program product of claim 12, further comprising computer usable program code for filtering the listing of questions according to a criterion of most popular questions.

14. The computer program product of claim 12, further comprising computer usable program code for filtering the listing of questions according to a criterion of most recently posed questions.

15. The computer program product of claim 9, further comprising computer usable program code for linking the selected question and the different answer with the received question and corresponding answer.
